(19) United States
(12) Patent Application Publication
(10) Pub. No.: US 2025/0110672 A1
(43) Pub. Date: Apr. 3, 2025

(54) INFORMATION PROCESSING DEVICE UPDATING PARAMETER RELATED TO COLOR BALANCE FOR USE IN PRINTING ACCORDING TO SUPPORT PROGRAM

(71) Applicant: BROTHER KOGYO KABUSHIKI KAISHA, Nagoya (JP)

(72) Inventors: Yoshito HOSOMIZO, Konan (JP); Kenju NARITA, Nagoya (JP); Airi EGUCHI, Ichinomiya (JP)

(21) Appl. No.: 18/829,473

(22) Filed: Sep. 10, 2024

(30) Foreign Application Priority Data
Sep. 28, 2023 (JP) 2023-167633

(51) Int. Cl. G06F 3/12; H04N 1/00; H04N 1/60

(52) U.S. Cl. CPC G06F 3/1208; H04N 1/0044; H04N 1/6077

(57) ABSTRACT

An information processing device has an operating system including a general-purpose printing program. In a case that a print instruction to execute a printing of a target image on a printing device is issued from an application program to the general-purpose printing program and intermediate data representing the target image is received, a computer of the information processing device performs, according to a support program corresponding to the printing device, a preview process of displaying a preview image of the target image, and a settings modification process of, while the preview image is displayed, receiving a modification of a setting value for a parameter related to color balance. In a case that the setting value is modified in the settings modification process, the computer performs, according to the support program, a print control process of causing the printing device to print the target image according to the modified setting value.

### REFERENCE TO RELATED APPLICATIONS

This application claims priority from Japanese Patent Application No. 2023-167633 filed on Sep. 28, 2023. The entire content of the priority application is incorporated herein by reference.

### BACKGROUND ART

Technologies that use a personal computer or other information processing device to control a printer are well known in the art. For example, a printer driver provided by a printer vendor is configured to control a computer to display a screen for adjusting colors in an image by accepting modifications through this screen to modify the values of settings such as hue, saturation, and brightness.

### SUMMARY

In recent years, practical technologies have been developed for controlling printers without the use of a printer driver provided by a printer vendor. One such technology utilizes a general-purpose printing program as a part of the operating system (OS) as standard. With this technology, the OS, upon detecting a printer, associates the printer with the OS-standard general-purpose printing program. Thereafter, when a print instruction is received from that printer, the OS-standard general-purpose printing program generates print data without the need for a printer driver provided a vendor of that printer, and thus can control printing based on the print data.

However, the OS-standard general-purpose printing program described above does not have a color adjustment function that accepts modifications to the values of settings related to color balance, as printer drivers provided by printer vendors have conventionally possessed. Accordingly, adjustments to color balance described in the conventional technology are not easily achieved with the OS-standard general-purpose printing program, which may result in images not being printed in the user's desired color tones.

In view of the foregoing, it is an object of the present disclosure to provide an image forming apparatus a non-transitory computer readable storage medium storing instructions of a support program. The support program is a program corresponding to a printing device connected to an information processing device. The information processing device includes a computer. The information processing device has an operating system installed thereon. The operating system includes a general-purpose printing program. The instructions of the support program, when executed by the computer, causing the information processing device to perform: in a case that a print instruction to execute a printing of a target image on the printing device is issued from an application program running on the information processing device to the general-purpose printing program and intermediate data representing the target image is received from the general-purpose printing program, a preview process of displaying a preview image of the target image on a user interface of the information processing device; and a settings modification process of, while the preview image is displayed on the user interface, receiving a modification of a setting value for a parameter related to color balance and modifying the setting value; and in a case that the setting value is modified in the settings modification process, a print control process of causing the printing device to print the target image according to the modified setting value.

In the above structure, the information processing device in which the support program is implemented can perform the printing the target image in the color tones in accordance with the user's preferences.

### BRIEF DESCRIPTION OF DRAWINGS

FIG. 1 is a block diagram illustrating an electrical configuration of a personal computer.

FIG. 2 is a sequence diagram illustrating an example of a print setup procedure.

FIG. 3 is an explanatory diagram illustrating an example of an advanced settings screen.

FIG. 4 is a sequence diagram illustrating an example of a printing procedure.

FIG. 5 is a flowchart illustrating an example of a color adjustment preview process.

FIG. 6 is an explanatory diagram illustrating an example of a preview screen.

FIG. 7 is an explanatory diagram illustrating an example of a saving options screen.

FIG. 8 is an explanatory diagram illustrating another example of a saving options screen.

FIG. 9 is an example of a table including sets of setting values for a color adjustment.

FIG. 10 is an explanatory diagram illustrating another example of a preview screen.

### DESCRIPTION

Below, a personal computer (PC) using an auxiliary program as a support program according to an embodiment will be described while referring to the accompanying drawings. This specification describes the support program executed on the PC. Note that the support program can be run on smartphones and mobile computers, as well as PCs.

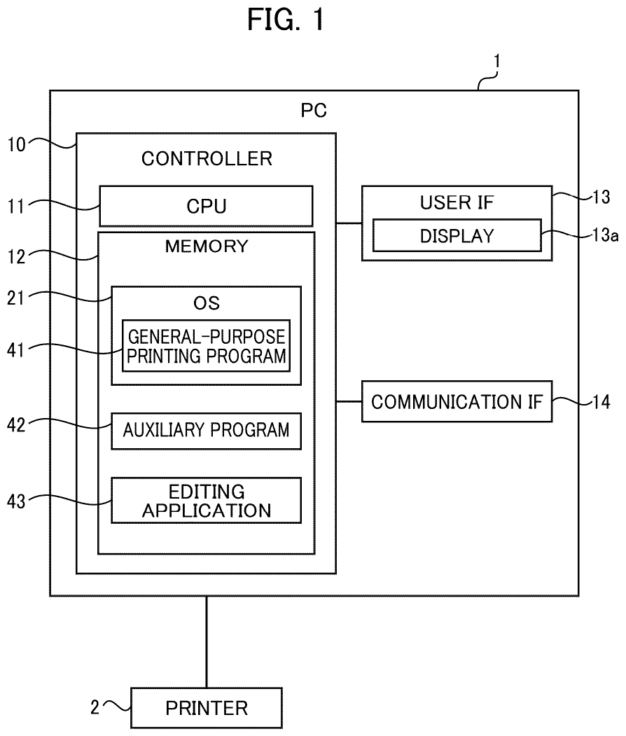

As shown in FIG. 1, the PC 1 of the embodiment is provided with a controller 10 that includes a CPU 11 and a memory 12. The PC 1 is an example of the information processing device of the present disclosure. The CPU 11 is an example of the computer and the processor of the present disclosure. The PC 1 is also provided with a user interface (also described as “user IF”) 13, and a communication interface (also described as “communication IF”) 14, both of which are electrically connected to the controller 10. Note that the controller 10 in FIG. 1 is a general concept that covers all hardware and software used for controlling the PC 1 and is not actually limited to representing a single piece of hardware present in the PC 1. The controller 10 may be an example of the computer and the processor.

The CPU 11 of the PC 1 executes various processes according to programs read from the memory 12 or based on user operations. The memory 12 stores various data and various application programs (hereinafter referred to as “apps”). The memory 12 is used as a work area for executing various processes. A buffer provided in the CPU 11 is also one example of a memory. Examples of the memory 12 may be a ROM, a RAM, a hard disk drive, or the like built into the PC 1 or may be any storage medium that is readable and writable by the CPU 11, such as a CD-ROM, a DVD-ROM, a USB memory, or other storage media.

The user interface 13 includes hardware that displays screens for reporting information to the user, and specifically a display 13a, and hardware that receives user operations. The user interface 13 may be a set of devices that includes the display 13a for displaying information, and a mouse, keyboard, and the like having input-receiving functions. Alternatively, the user interface 13 may be a touchscreen that is provided with both the function of the display 13a and an input-receiving function.

The communication interface 14 includes hardware that communicates with external devices such as a printer 1. That is, the communication interface 14 may be a network interface. The communication interface 14 employs, as a communication standard, Ethernet, Wi-Fi (U.S. trademark of Wi-Fi Alliance CORPORATION), or USB, for example. The PC 1 may be capable of connecting to the Internet 100 via the communication interface 14. Alternatively, the PC 1 may be provided with a plurality of communication interfaces 14 supporting a plurality of communication standards.

As shown in FIG. 1, the memory 12 of the PC 1 stores various programs and various data including an operating system (hereinafter “OS”) 21, an auxiliary program 42, and an editing application 43. The OS 21 includes a general-purpose printing program (universal printing program, or generic program) 41. The auxiliary program 42 is an example of the set of support program instructions, and the editing application 43 is an example of the set of application program instructions.

The OS 21 is a multitask OS that handles task management to execute concurrently the plurality of tasks while switching the tasks. The OS 21 is one of Windows (U.S. trademark of Microsoft Corporation), macOS (U.S. trademark of Apple Inc.), Linux (U.S. trademark of Torvalds, Linus), iOS (U.S. trademark of Cisco Technology, Inc.), and Android (U.S. trademark of Google LLC Limited), for example.

The general-purpose printing program 41 is implemented (or embedded) in the OS 21. The general-purpose printing program 41 is an OS-standard program prepared by the vendor of the OS 21 and provided as part of the OS 21. In other words, the OS 21 having the general-purpose printing program 41 is installed on the PC 1. The general-purpose printing program 41 is not configured to use printer drivers specific to individual printers.

The general-purpose printing program 41 functions to execute printing, which is based on user instruction, on a plurality of models of printers provided by a plurality of vendors. The general-purpose printing program 41 supports generic functions that allow printing to be performed on many printers. Unlike printer drivers designed for specific types of printers, the general-purpose printing program 41 does not support functions that are specific to each printer or printer driver, particularly those functions that require complex processing.

The general-purpose printing program 41 includes functions for receiving image data specified as the printing target in print instructions outputted from various apps based on user instructions and for generating intermediate data based on that image data. An example of intermediate data is XML Paper Specification (XPS) data. Here, XML is an abbreviation of Extensible Markup Language. The general-purpose printing program 41 also has a function for generating print data based on intermediate data in a format that can be used for printing on various printers. An example of print data is PWG Raster data or PDF data. Here, PWG is an abbreviation of Printer Working Group, and PDF is an abbreviation of Portable Document Format. The general-purpose printing program 41 also has a function for transmitting the generated print data to a printer designated as the device for executing the print via a communication function of the OS 21.

The auxiliary program 42 is a program or a set of programs that execute processes based on instructions from the OS 21 in conjunction with the processes of the general-purpose printing program 41 and is a program that provides control support for the target hardware. The auxiliary program 42 of the present embodiment supports the model of printer 2 connected to the PC 1 and is provided by the vendor of the printer 2, for example. That is, the auxiliary program 42 is designed for the model of printer 2. The general-purpose printing program 41 starts the auxiliary program 42 associated with the printer 2 in the following cases including: a case that the printer 2 is selected as the device to execute a print, a case that an instruction for advanced print settings is received while the printer 2 is selected, and a case that an instruction to execute a print on the printer 2 is received. To start the auxiliary program 42, the general-purpose printing program 41 or the OS 21 may issue a starting instruction to starts the auxiliary program 42. The auxiliary program 42 is called as a Print Support Application (PSA) or a Hardware Support Application (HSA), for example.

The auxiliary program 42 may be a combination of a plurality of programs, each of which receives execution commands, or may be a single program that can execute different processes according to the received commands. The vendors of printers may prepare an auxiliary program for each type or model of printer. For example, one auxiliary program may be prepared for inkjet printers and another auxiliary program may be prepared for laser printers. Alternatively, an auxiliary program may be prepared for each model series rather than each type of printer.

When a new printer is connected to the PC 1, for example, the OS 21 of the PC 1 can download the appropriate auxiliary program from a server of the vendor of the printer or the like based on the type or model of the connected printer and can install this program on the PC 1. The OS 21 stores identification information for the installed auxiliary program in the memory 12 in association with printer information on the newly connected printer.

The editing application 43 is a program used for creating and editing image data and document data, for example. Examples of the editing application 43 include Word and PowerPoint (U.S. trademark of Microsoft Corporation) developed by Microsoft (U.S. trademark of Microsoft Corporation), and a program provided by the vendor of the printer 2. The editing application 43 accepts instructions via the user interface 13, such as a print execution instruction for instructing the printer 2 to execute a print. The editing application 43 is not limited to a program for creating and editing data but may be a program that accepts print execution instructions and display instructions for displaying various types of information, such as map information and web pages, in response to user requests.

As shown in FIG. 1, the PC 1 of the present embodiment is connected to the printer 2 via the communication interface 14. The printer 2 is a device having at least a printing function and a communication function. When print data is received from the PC 1 or the like, for example, the printer 2 can execute a print operation based on this print data. The printer 2 is capable of performing color printing in this example.

The following is a description of steps in various processes for controlling the printer 2 to perform a printing operation. The processes in the present embodiment essentially indicate processes performed by the CPU 11 according to commands described in the auxiliary program 42 and other programs. Processes performed by the CPU 11 include hardware control using the API in the OS 21. A detailed description of the role of the OS 21 is omitted in this specification when describing operations according to the programs. Further, the term “acquire” is used as a concept that does not necessarily require a request.

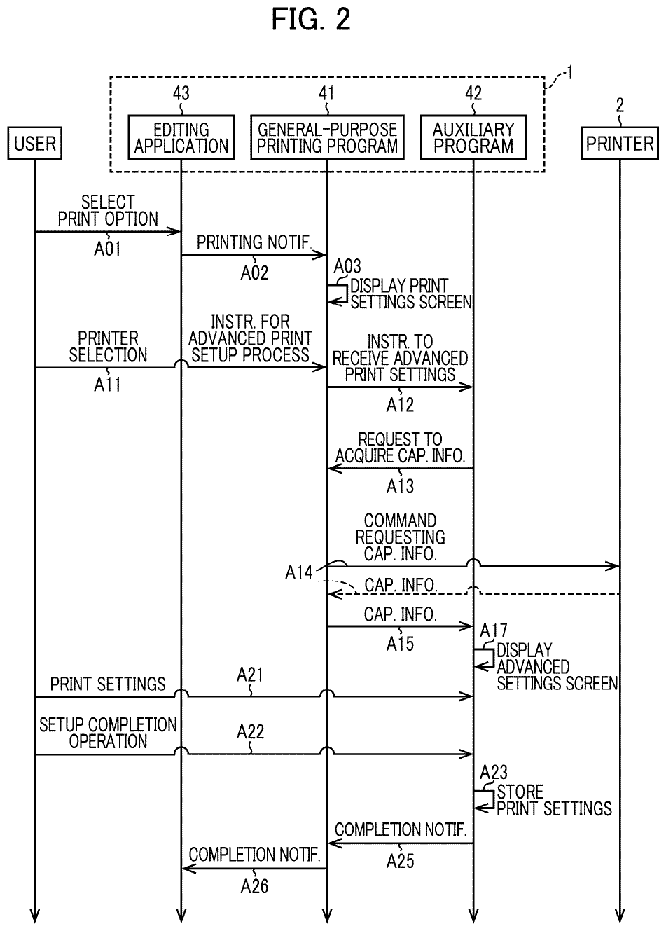

Here, steps in a printing procedure will be described with reference to the sequence chart in FIG. 2, beginning with a print setup procedure for accepting print settings. The editing application 43 accepts user instructions to create and edit text and images. When the user wishes to print the displayed text and images, in A01 the user selects an option to print in the editing application 43. For example, the user can select the option “Print” from a menu of operations provided in the editing application 43.

Upon receiving the selection to print, in A02 the editing application 43 notifies the general-purpose printing program 41 in the OS 21 that a printing-related instruction was received. Upon receiving this notification from the editing application 43, in A03 the general-purpose printing program 41 displays a print settings screen on the user interface 13. The print settings screen is a screen for accepting user instructions for various print settings supported by the general-purpose printing program 41. As an alternative, the editing application 43 may display the print settings screen.

Through the displayed print settings screen, the general-purpose printing program 41 can accept instructions to select a device for executing the print and to start an advanced print setup process. In the example of FIG. 2, in All the general-purpose printing program 41 receives an instruction to begin the advanced print setup process while the printer 2 is selected as the device to perform printing. Upon receiving this instruction, in A12 the general-purpose printing program 41 starts up the auxiliary program 42 associated with the printer 2 and passes the auxiliary program 42 an instruction to begin accepting advanced print settings.

When started up in response to the instruction received in A12, the auxiliary program 42 obtains capability information on the printer 2. For example, in A13 the auxiliary program 42 issues a request to the general-purpose printing program 41 to acquire the capability information. In A14 the general-purpose printing program 41 transmits a command requesting capability information to the printer 2 and subsequently acquires the capability information from the printer 2. In A15 the general-purpose printing program 41 passes the capability information acquired in A14 to the auxiliary program 42. In this way, the auxiliary program 42 can obtain capability information on the printer 2.

In A14 the general-purpose printing program 41 communicates with the printer 2 via the OS 21 according to the Internet Printing Protocol (IPP), for example. Note that rather than sending a request to the general-purpose printing program 41, the auxiliary program 42 may acquire the capability information directly from the printer 2 using a management information base (MIB), for example.

The capability information acquired from the printer 2 includes information on possible parameters for print settings. The capability information may further include information on residual quantities of consumables, selectable trays, the paper loaded in each tray, and supported print resolutions, for example. The printer 2 may also have functions for processing images based on received print instructions, and printing based on the processed image data. For example, the printer 2 may have functions for reducing paper usage such as a function for performing N-in-1, and a function for composite printing to include watermarks or the like, and a function for economic printing for saving colorant. In a case that the printer 2 possesses applicable image processing functions, the printer 2 may include information on these functions in the capability information to be transferred. The printer 2 may also include information specifying its own status in the capability information.

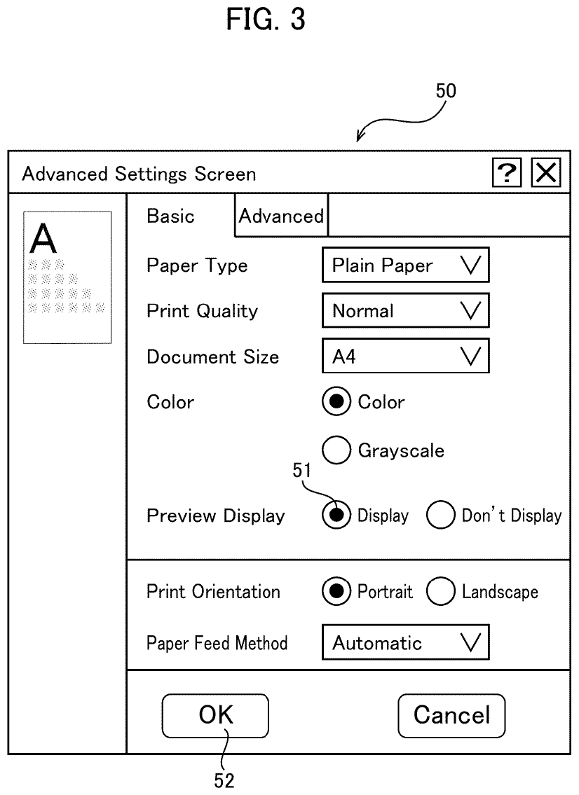

In A17 the auxiliary program 42 displays an advanced settings screen on the user interface 13 based on the acquired capability information. The auxiliary program 42 can accept advanced print settings in this screen. FIG. 3 shows an example of an advanced settings screen 50 displayed by the auxiliary program 42. Parameters that are supported by the printer 2 are included in the advanced settings screen 50 as options. In A21 the auxiliary program 42 can receive various print settings through user operations in the advanced settings screen 50.

The advanced settings screen 50 includes a radio button 51 that accepts a selection to display a preview screen prior to printing, and an OK button 52 that accepts an instruction to end the advanced print setup process, for example. The process to receive an operation of the radio button 51 is an example of the selection process.

As will be described later, the auxiliary program 42 can accept modifications to the setting values for items related to color balance while the preview image is displayed. In this case, the radio button 51 may become operable when the “Color” option is selected as the color setting. The auxiliary program 42 may also be configured to accept settings for the items related to color balance in the advanced settings screen 50, for example. In other words, the setting values for the items related to color balance may be the setting values inputted into parameters related to color balance.

When the auxiliary program 42 receives an operation on the OK button 52 in A22, in A23 the auxiliary program 42 stores the print settings (setting values) received through the advanced settings screen 50 and in A25 notifies the general-purpose printing program 41 that the reception of advanced print settings has ended. In response to this notification from the auxiliary program 42, in A26 the general-purpose printing program 41 notifies the editing application 43 that the print setup is complete. The auxiliary program 42 may also notify the editing application 43 directly that the reception of print settings is complete. At this time, the editing application 43 can receive user instructions for executing or canceling printing.

Note that the print settings screen displayed by the general-purpose printing program 41 in A03 may also include an information display area for displaying an image prepared by the auxiliary program 42. When an operation is received in this information display area, the general-purpose printing program 41 may pass information on the operation to the auxiliary program 42. In this case, the auxiliary program 42 may display radio buttons in the information display area for accepting a selection of whether to display a preview image prior to printing, for example.

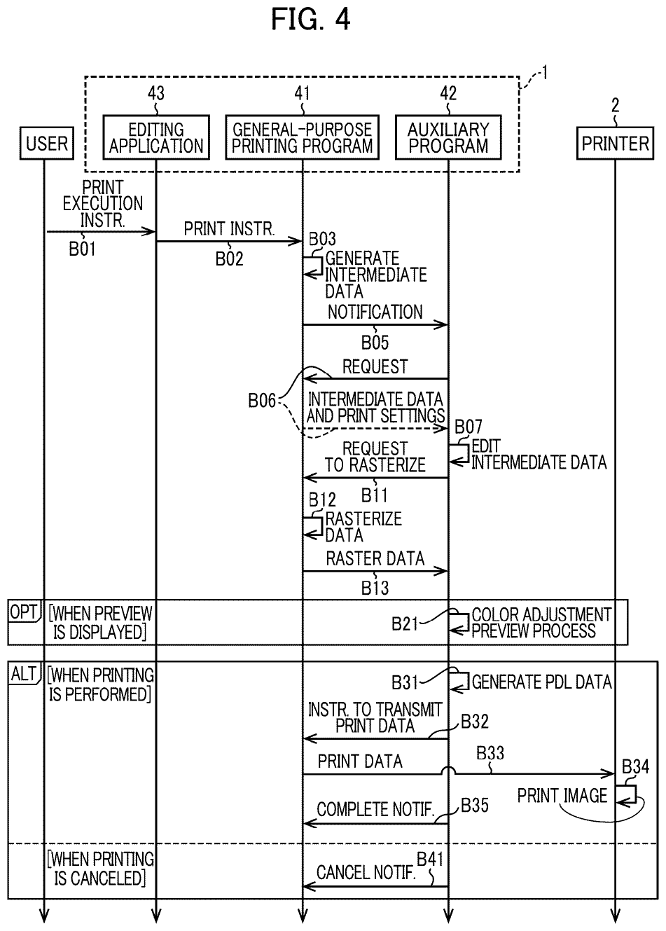

Next, a printing procedure will be described with reference to the sequence chart in FIG. 4. After finalizing the image to be printed and the print settings, in B01 the user inputs an instruction in the editing application 43 to execute the print. When the OS 21 includes the general-purpose printing program 41, the editing application 43 can accept an execution instruction to have the general-purpose printing program 41 print the selected image on the printer 2.

In B02 the editing application 43 passes information on the received print execution instruction to the general-purpose printing program 41. The editing application 43 may transmit a print instruction to the general-purpose printing program 41. Here, the print instruction is based on the print execution instruction received in B01. The general-purpose printing program 41 acquires image data representing the image to be printed and information specifying the print settings from the editing application 43 as the information of the print instruction.

In B03 the general-purpose printing program 41 generates intermediate data by converting the format of the image data representing the image to be printed to the format of the intermediate data based on the information acquired from the editing application 43. The editing application 43 generates image data of various types, and thus the general-purpose printing program 41 converts the image data to be printed to intermediate data that is suitable for generating print data. When the image data to be printed is already suitable for generating print data, the general-purpose printing program 41 may skip the process to generate intermediate data and may use the image data received from the editing application 43 as the intermediate data.

The general-purpose printing program 41 may also start up the auxiliary program 42 corresponding to the printer 2, which is the designated printing device, prior to generating the intermediate data. When starting up the auxiliary program 42, the general-purpose printing program 41 notifies the auxiliary program 42 that processing has begun on a print job associated with the print instruction outputted from the editing application 43. When started up from the general-purpose printing program 41, the auxiliary program 42 can pass information to the general-purpose printing program 41 as needed, including various instructions to be used for generating the intermediate data.

After generating the intermediate data, in B05 the general-purpose printing program 41 starts up the auxiliary program 42 and notifies the auxiliary program 42 that intermediate data was generated. In B06 the auxiliary program 42 sends a request to the general-purpose printing program 41 requesting the intermediate data generated by the general-purpose printing program 41 and information on print settings associated with this print job, for example. Thereafter, the auxiliary program 42 receives the intermediate data generated by the general-purpose printing program 41 and information on the print settings associated with this print job from the general-purpose printing program 41.

The auxiliary program 42 can then check the intermediate data and the information on print settings received from the general-purpose printing program 41 based on previously received print settings (e.g., the print settings (setting values) stored in A23 of FIG. 2) and the capabilities of the printer 2. In B07 the auxiliary program 42 edits the intermediate data as needed.

Note that the procedure for acquiring capability information on the printer 2 (A13-A15 of FIG. 2) may not have been executed in cases that the print setup procedure of FIG. 2 was not executed, such as a case that a print execution instruction was received without any user instructions for print settings. In a case that the auxiliary program 42 has not obtained capability information on the printer 2, the auxiliary program 42 may request the general-purpose printing program 41 to acquire the capability information upon receiving the notification in B05, for example.

In B11 the auxiliary program 42 transfers the intermediate data that was checked and edited in B07 to the general-purpose printing program 41 and requests the general-purpose printing program 41 to rasterize this data. In B12 the general-purpose printing program 41 rasterizes the intermediate data to generate raster data, which is bitmap data in this embodiment. In B13 the general-purpose printing program 41 transfers the generated raster data to the auxiliary program 42, whereby the auxiliary program 42 acquires the raster data. The series of the processes of B11-B13 is an example of the rasterization process.

The auxiliary program 42 may also perform this rasterization in place of the general-purpose printing program 41. In this case, the auxiliary program 42 rasterizes the intermediate data to generate raster data. This process to generate the raster data performed by the auxiliary program 42 is an example of the rasterization process.

The auxiliary program 42 has a greater degree of freedom for rasterizing intermediate data than the general-purpose printing program 41 and is more likely to generate raster data that is suitable for printing on the printer 2. On the other hand, performing rasterization with the general-purpose printing program 41 can reduce processing load on the auxiliary program 42 and can reduce the size of the auxiliary program 42.

When the print settings received by the auxiliary program 42 include information specifying a selection to display a preview image (opt: display preview), in B21 the auxiliary program 42 executes a color adjustment preview process. In the color adjustment preview process, the auxiliary program 42 displays a preview image and accepts modifications to setting values for items related to color balance.

For example, in a case that the auxiliary program 42 receives an operation on the OK button 52 in the advanced settings screen 50 shown in FIG. 3 while the radio button 51 indicating a selection to display a preview image is selected, the auxiliary program 42 determines that the option to display a preview image has been selected. On the other hand, in a case that the auxiliary program 42 receives an operation on the OK button 52 while the radio button 51 is not selected, the auxiliary program 42 determines that the option to display a preview image has not been selected and does not perform the color adjustment preview process.

The user might become annoyed in a conceivable case that a preview image is displayed every time a print instruction is issued. In the present embodiment, the auxiliary program 42 accepts a selection of whether to display a preview image prior to printing. The auxiliary program 42 displays a preview image when a selection to display the preview image is received and does not display a preview image when a selection to display the preview image is not received. In the latter case, the auxiliary program 42 performs a printing process without accepting changes to setting values for items related to color balance. Thus, the user can complete printing quickly without feeling any annoyance at seeing a preview display when such a display is unnecessary.

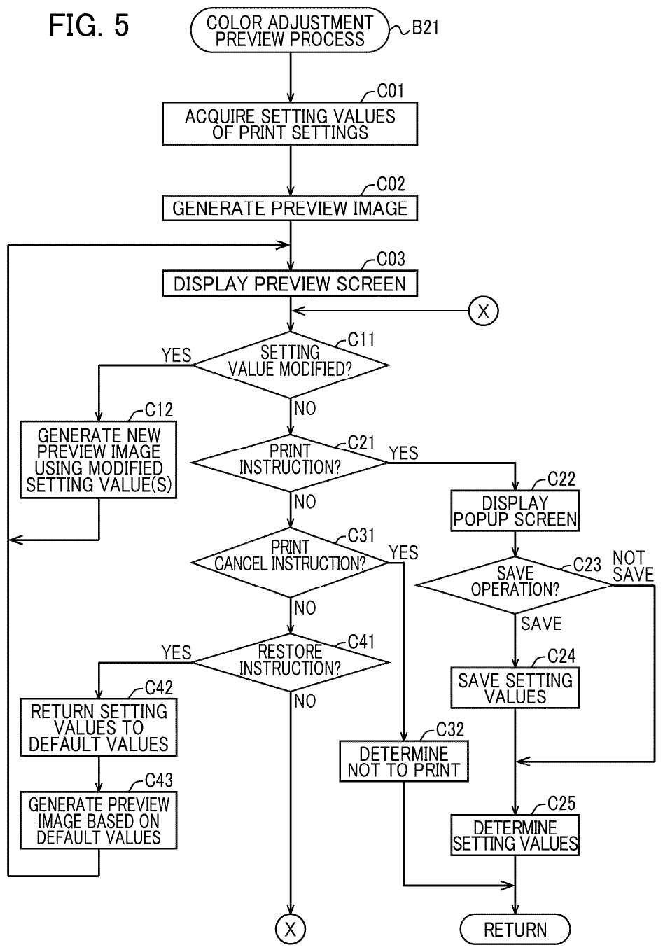

Next, the color adjustment preview process will be described with reference to the flowchart in FIG. 5. The CPU 11 of the PC 1 executes this process based on the description in the auxiliary program 42. In C01 at the beginning of the color adjustment preview process, the CPU 11 acquires setting values for the items related to color balance included in the print settings provided with the print instruction. Examples of the items related to color balance are brightness, contrast, saturation, and color intensity for each RGB color. The CPU 11 acquires the setting value for each item. The auxiliary program 42 may also be able to accept a setting value for a black intensity item. The CPU 11 will use the setting values obtained in C01 as default values.

The print settings may be included in the information that the auxiliary program 42 obtains from the general-purpose printing program 41 in B06 of the print execution procedure described in FIG. 4, for example. Further, in a case that the auxiliary program 42 stored print settings received from the user in A23 while executing the print setup procedure shown in FIG. 2, for example, in C01 the CPU 11 may obtain setting values for the items related to color balance from the print settings stored in A23. In a case that the print settings do not include information on setting values for the items related to color balance, the CPU 11 may acquire standard setting values for the items related to color balance provided in the auxiliary program 42.

In C02 the CPU 11 uses the setting values for the items related to color balance that were acquired in C01 to generate a preview image of raster data for the image to be printed. The raster data for the image to be printed was acquired from the general-purpose printing program 41 in B13 of the print execution procedure in FIG. 4. Raster data generated by the general-purpose printing program 41 is bitmap data in which each dot is expressed in RGB values. The method of rasterization may change some color tones in the image to be printed. In other words, the color tones in the image to be printed may change depending on the method. In this embodiment, the CPU 11 displays a preview image corresponding to the raster data to display an image that will closely resemble the printing results.

Note that the items related to color balance may include items that are supported by the general-purpose printing program 41 and items that are not supported. In a case that settings (setting values) for items related to color balance are reflected in the rasterization by the general-purpose printing program 41, in C02 the CPU 11 may simply use the raster data acquired from the general-purpose printing program 41 to generate a preview image. However, in a case that one or more setting values for one or more items related to color valance are not reflected in the rasterization by the general-purpose printing program 41, the CPU 11 may use the setting values related to color valance and obtained in C01 to adjust the raster data acquired from the general-purpose printing program 41 and may generate a preview image in C02 based on the adjusted raster data.

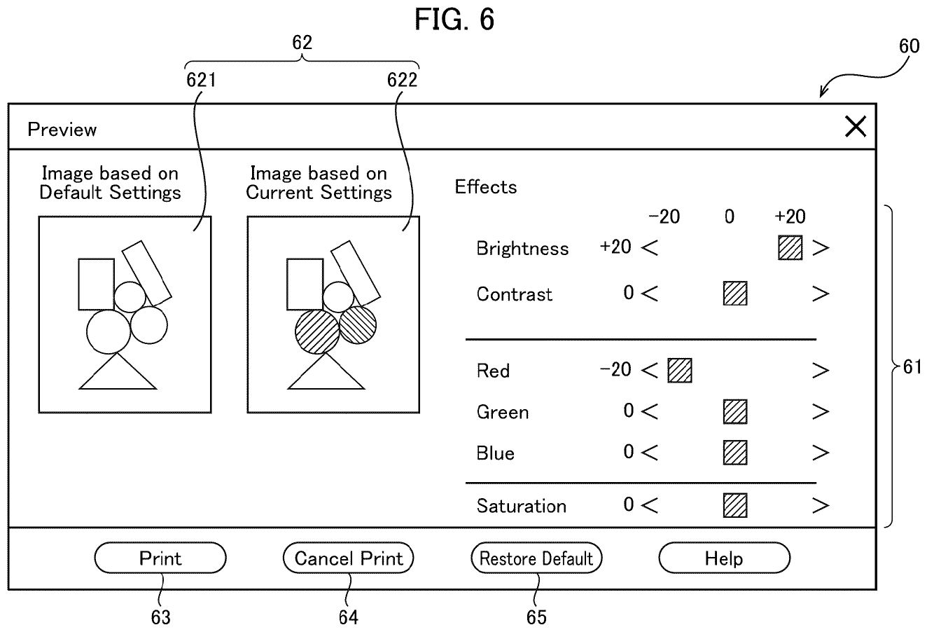

In C03 the CPU 11 displays a preview screen on the display 13a of the user interface 13. The preview screen includes the preview image generated in C02 and accepts changes to setting values for items related to color balance. FIG. 6 shows an example of such a preview screen 60. The preview screen 60 in this example includes a color settings area 61, a preview area 62, and a plurality of buttons 63-65 that accept user instructions. The color settings area 61 accepts modifications to the setting values of various items related to color balance included in the print settings. For each item in the color settings area 61 of the preview screen 60, the CPU 11 can accept a value within a range of −20 to +20, for example, which indicates the degree of deviation from the standard value possessed by the auxiliary program 42.

The preview area 62 shows preview images representing the image to be printed. In the present embodiment, the auxiliary program 42 displays a preview screen 60 that includes two preview images: a preview image 621 that is rendered based on the default values for the items related to color balance acquired in C01, and a preview image 622 that is rendered based on the latest values for the items related to color balance displayed in the color settings area 61 of the preview screen 60. When initially displaying the preview area 62 in C03 prior to receiving any operations in the color settings area 61, the preview image 621 and preview image 622 are identical. That is, the preview image 621 is the image generated in CO2 while the preview image 622 in this case is a copy of the preview image 621. The process of C03 is an example of the preview process.

The buttons 63-65 include a Print button 63, a Cancel Print button 64, and a Restore Default button 65. The Print button 63 accepts an instruction to execute a print using the setting values currently displayed in the color settings area 61. The Cancel Print button 64 accepts an instruction to cancel printing of the target image. The Restore Default button 65 accepts an instruction to restore setting values displayed (or indicated) in the color settings area 61 to the default values acquired in C01.

While the color settings area 61 and the preview area 62 are both displayed in the same preview screen 60 in the example of FIG. 6, the color settings area 61 and preview images of the preview area 62 may instead be displayed in separate screens. For example, the CPU 11 may first display just the preview image 621 and may subsequently display the preview image 622 and color settings area 61 upon receiving a user operation. In this case, the preview image 621 may be replaced with the preview image 622. Such a configuration gives the preview screen 60 a simple display that the user can more readily understand. On the other hand, in a case that both the color settings area 61 and the preview area 62 are displayed in the same preview screen 60, as in the example of FIG. 6, the user can easily see the current setting values and the preview image produced by those setting values at a glance, making it easier to adjust the color balance.

At this time, the CPU 11 accepts user operations in the preview screen 60 displayed on the display 13a. In C11 the CPU 11 determines whether an instruction was received to modify a setting value for one of the items in the color settings area 61. When the CPU 11 determines that an instruction to modify a setting value was received (C11: YES), in C12 the CPU 11 uses the modified setting value to generate a new preview image representing the image to be printed. Subsequently, the CPU 11 returns to C03 and redisplays the preview screen 60. Thus, whenever the CPU 11 receives a change to a setting value for an item related to color balance, the CPU 11 changes the preview image 622 according to this modification.

For example, when the setting value for the brightness item was changed to a higher value, the CPU 11 generates the preview image 622 by increasing the RGB values overall for each dot. As another example, when the setting value for the red item was changed to a smaller value, the CPU 11 generates the preview image 622 with a smaller R value for each dot.

Note that the CPU 11 only modifies the preview image 622 and not the preview image 621 in this case. That is, when an instruction to modify a setting value is received, the CPU 11 modifies and displays the single preview image 622 according to this instruction while displaying the other preview image 621 with the default values unchanged. In this way, the user can easily discern changes in printing results and changes in color tones resulting from the modified setting value, making it easy to adjust the color balance. The process of C11 is an example of the setting modification process. The series of processes of C12 and C03 is an example of the preview modification process.

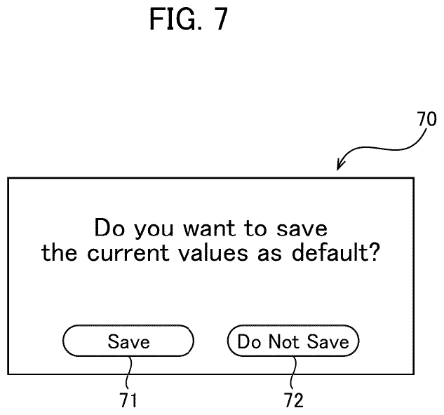

However, when the CPU 11 determines that an instruction to modify a setting value was not received (C11: NO), in C21 the CPU 11 determines whether a print instruction was received through an operation on the Print button 63. When the CPU 11 determines that a print instruction was received (C21: YES), in C22 the CPU 11 displays a popup screen on the user interface 13 to receive a user selection indicating whether to store the setting values of the items related to color balance, which is to be used in the current print, as default values for the next print. For example, the CPU 11 displays a saving options screen 70, as illustrated in FIG. 7. Here, the saving options screen 70 includes a Save button 71, and a Do Not Save button 72. In C23 the CPU 11 waits until an operation on one of the buttons 71 and 72 is received. The series of processes of C22-C23 is an example of the storage instruction process.

When the CPU 11 determines that an operation on the Save button 71 was received (C23: save), in C24 the CPU 11 stores the current setting values displayed (or indicated) in the color settings area 61 in the memory 12 as default values for the next print instruction. The CPU 11 may skip the process in C22-C24 in a case that the CPU 11 did not receive no instruction to change one or more setting values in C11 (i.e., when there was no YES determination in C11) or in a case that the setting values of the items displayed in the color settings area 61 when an operation on the Print button 63 is received match the default values. In a case that default values for the items related to color balance used in the previous print are currently stored in the memory 12, in C24 the CPU 11 may overwrite the stored values with the setting values of the items related to color balance to be used in the current print. The process of C24 is an example of the storage process.

In a case that a new print instruction is received while setting values for the items related to color balance are stored in the memory 12, the auxiliary program 42 reads the setting values for the items related to color balance from the memory 12 and includes these setting values for the items related to color balance in the print settings to be used. For example, when the auxiliary program 42 displays the advanced settings screen in A17 of the print setup procedure shown in FIG. 2, the auxiliary program 42 can read the setting values for the items related to color balance from the memory 12 and apply these setting values to a portion of the print settings. By storing the setting values of the items related to color balance used in the current print as default values to be used as print settings for subsequent prints, the user can ensure that the next print achieves the same color balance.

Following C24 or when the CPU 11 received an operation on the Do Not Save button 72 shown in FIG. 7 (C23: do not save), in C25 the CPU 11 sets the current setting values displayed in the color settings area 61 as the setting values for the items related to color balance for the current print. In other words, the CPU 11 can store modified setting values for the items related to color balance when an instruction to store the setting values is received whereas the CPU 11 can also accept an instruction not to store the modified settings when the user only wishes to change the color balance temporarily. This gives the user great flexibility in modifying the color balance.

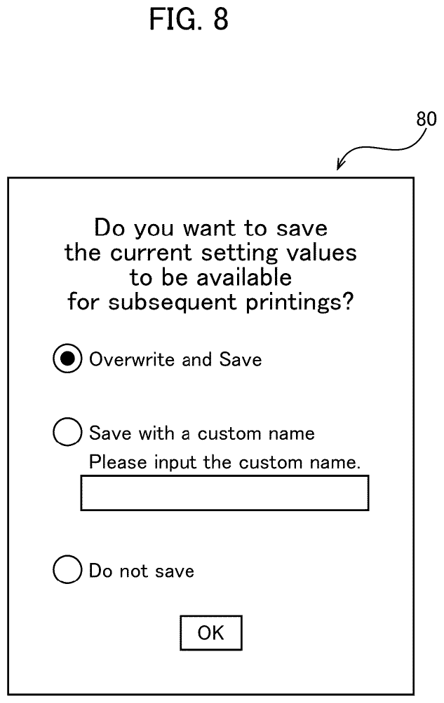

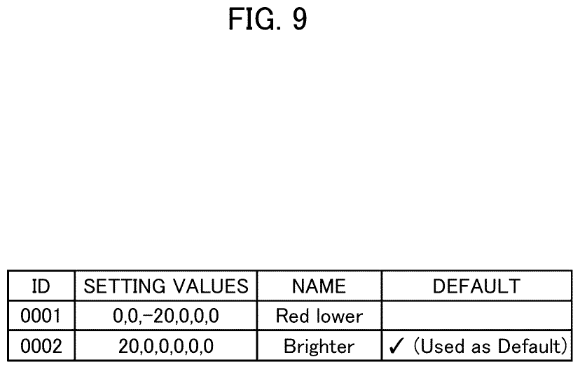

The auxiliary program 42 may also be capable of storing a plurality of sets of setting values rather than just the current set of setting values. In this case, in C22 the CPU 11 may display a saving options screen 80, as shown in the example of FIG. 8, on the user interface 13 as a popup screen. The saving options screen 80 is for accepting one of three options: “Overwrite,” “Save as . . . ,” and “Do not save.” When “Save as . . . ” is selected, the CPU 11 accepts additional user input for a name. As shown in the example of FIG. 9, the CPU 11 stores the current setting values in the memory 12 in association with the inputted name as one set of setting values.

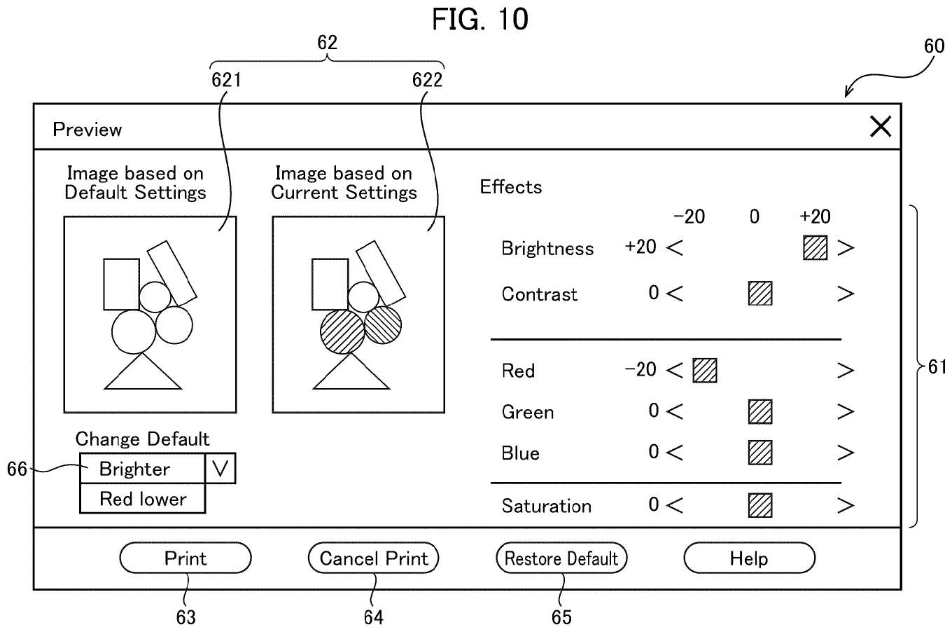

When a plurality of sets of setting values is stored in the memory 12, the CPU 11 may provide the preview screen 60 with a selection field 66 for receiving a selection for a set of setting values for the items related to color balance, as shown in the example of FIG. 10. Thus, the CPU 11 can receive a user selection for a set of default values from among the plurality of saved sets. When the CPU 11 can save a plurality of sets of setting values and can accept a selection of one of the stored sets when setting the color balance in the print settings, the user can selectively reuse past sets of modified setting values and can easily adjust colors to preferred tones.

On the other hand, when the CPU 11 determines that a print instruction was not received (C21: NO), in C31 the CPU 11 determines whether a print cancel instruction was received through an operation on the Cancel Print button 64. When the CPU 11 determines that an instruction to cancel printing was received (C31: YES), in C32 the CPU 11 makes the determination not to print and ends the color adjustment preview process.

However, when the CPU 11 determines that an instruction to cancel printing was not received (C31: NO), in C41 the CPU 11 determines whether an operation on the Restore Default button 65 was received. When the CPU 11 determines that an instruction to restore setting values to their default values was received through an operation on the Restore Default button 65 (C41: YES), in C42 the CPU 11 returns the setting values displayed in the color settings area 61 to the default values.

In C43 the CPU 11 then generates a preview image using the default values as setting values for the items related to color balance and returns to C03 to display the new preview image as the preview image 622. In this case, the CPU 11 may generate the preview image 622 by copying the preview image 621. The operation on the Restore Default button 65 or the instruction based on this operation is an example of the initialization process and the reset process. The series of processes C43 and C03 is an example of the settings initialization process and the example of the reset process.

Sometimes after modifying setting values in the color settings area 61 of the preview screen 60, a user may decide that the color balance with default values was better and may be unable to manually return to the default value color balance easily due to having performed multiple changes. Since the CPU 11 can simply restore the settings to their default values upon receiving an operation on the Restore Default button 65, the user can more easily adjust the color balance.

In a case that the plurality of sets of setting values is stored in the memory 12 and the CPU 11 receives a user selection for a set of default values from among the plurality of saved sets using the selection field 66 in the preview screen 60 shown in FIG. 10, the processes of C42 and C43 may be performed to generate a preview image based on the selected set of default values.

Further, when the CPU 11 determines in C41 that an operation on the Restore Default button 65 was not received (C41: NO), the CPU 11 waits until a user operation results in a YES determination for one of steps C11, C21, C31, and C41. Following step C25 or C32, the CPU 11 ends the color adjustment preview process and returns to the print execution procedure in FIG. 4.

Returning to the description of the print execution procedure in FIG. 4, in B31 the auxiliary program 42 generates print data by encoding the raster data to create PDL data. Here, the auxiliary program 42 performs the process of B31 in a case that the color adjustment preview process of B21 is performed, the CPU 11 determines that a print is to be executed (C21: YES), and thereafter the CPU 11 sets the setting values for the items related to color balance (C25), or the auxiliary program 42 performs the process of B31 in a case that the option to display a preview image is not selected (alt: print). The print data generated in B31 is in a format that can be printed on the printer 2. The PDL data generated by the auxiliary program 42 may be in a format that can be used for printing on printers of models other than the model of the printer 2 as well as the printer 2.

In a case that the color adjustment preview process of B21 is performed, in B31 the auxiliary program 42 uses setting values set in C25 of the color adjustment preview process of B21 to generate PDL data with an adjusted color balance. The auxiliary program 42 may process the raster data based on the setting values for the items related to color balance or may process CMYK data produced by converting the RGB values to CMYK values. Thus, when the auxiliary program 42 receives modifications to setting values for items related to color balance, the auxiliary program 42 generates PDL data based on the modified raster data.

On the other hand, in a case that the option to not display a preview image is received, the auxiliary program 42 does not execute the color adjustment preview process but simply initiates the process to print without displaying a preview image and without changing the color balance. In this case, the auxiliary program 42 executes a process to print on the printer 2 based on the print settings acquired in B06 and other setting values set in the print settings stored in A23 of FIG. 2. In this case, printing can be completed quickly.

In B32 the auxiliary program 42 passes the print data generated in B31 to the general-purpose printing program 41 with an instruction to transmit the print data to the printer 2. In response to the instruction from the auxiliary program 42, the general-purpose printing program 41 transmits the print data to the printer 2 instructing the printer 2 to print the print data. In B34 the printer 2 executes a print based on the print data received in B33, thereby producing printed matter. In B35 the auxiliary program 42 notifies the general-purpose printing program 41 that the process related to the current print based on the print instruction in B32 has been completed. The process of B32 is an example of the process to print an image of the printing target on the printer 2.

While the auxiliary program 42 passes the print data to the general-purpose printing program 41 and the general-purpose printing program 41 passes the print data to the printer 2 in the above example, the auxiliary program 42 may instead transmit the print data to the printer 2 together with a print command instructing the printer 2 to execute a print. Further, when the print settings include settings for an image process that can be executed on the printer 2, for example, the auxiliary program 42 may generate a print command that includes information for this image process so that the image process is to be executed on the printer 2. In this case, the auxiliary program 42 notifies the general-purpose printing program 41 that the process has ended after the transmission of print data is complete.

On the other hand, when the CPU 11 decides in C32 not to print when executing the color adjustment preview process of B21, i.e., when the CPU 11 received an operation on the Cancel Print button 64 in the preview screen 60, in B41 the auxiliary program 42 notifies the general-purpose printing program 41 that printing was canceled. Accordingly, the general-purpose printing program 41 cancels the process of the current print job and does not instruct the printer 2 to print.

As described above, the auxiliary program 42 of the present embodiment displays a preview image corresponding to the image to be printed (C03 in the color adjustment preview process of FIG. 5) when the editing application 43 outputs a print instruction to the general-purpose printing program 41 (B02 of FIG. 4) and the general-purpose printing program 41 passes intermediate data to the auxiliary program 42 (B06 of FIG. 4). While this preview image is displayed, the auxiliary program 42 also accepts modifications to setting values for items related to color balance. When setting values were modified, the auxiliary program 42 controls the printer 2 to print according to the modified setting values, thereby enabling the user to print images adjusted to preferred color tones.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. For example, a device connected the PC 1 is not limited to the printer 2, but may be any device having a printing function, such as a multifunction peripheral, copier machine, and facsimile machine. The number of devices connected to the PC 1 is not limited to that shown in the drawings, but may be two or more.

For example, the advanced settings screen 50 shown in FIG. 3 displays the radio button 51 for accepting a selection indicating whether to display a preview image, but the advanced settings screen 50 may be configured not to receive such a selection. For example, the auxiliary program 42 may automatically display a preview image and interfaces for accepting changes to setting values for items related to color balance when the “Color” option is selected for selecting the color printing.

Further, when a print instruction is received in C21 of the color adjustment preview process, the CPU 11 displays a popup screen to receive a selection indicating whether to store the setting values for the items related to color balance, but the preview screen 60 may instead include a button for accepting an instruction to store the setting values. Alternatively, the CPU 11 may be configured not to accept a selection of whether to store settings. For example, the auxiliary program 42 may be configured to always store the latest setting values only.

The preview image 621 need not be displayed in the preview screen 60. That is, the auxiliary program 42 may be configured to display only the preview image 622 as the preview area 62. Further, the preview screen 60 may also be configured to accept changes to print settings other than those related to color balance. Further, the Restore Default button 65 may be omitted from the preview screen 60.

The auxiliary program 42 may also be able to accept modifications to values of items related to color balance in the advanced settings screen 50 (see FIG. 3), which is displayed in A17 of the print setup procedure described in FIG. 2. In this case, when the setting values for the items related to color balance are stored in the memory 12 in this case, the auxiliary program 42 may apply the stored settings as default values.

The general-purpose printing program 41 may start up the auxiliary program 42 after displaying the print settings screen, when the printer normally used was changed from another printer to the printer 2 via the OS 21 in response to a user operation. In this case, the auxiliary program 42 may also display an information screen for accepting modifications to the setting values of items related to color balance, for example. When setting values for the items related to color balance are stored as the default values in the memory 12 at this time, the auxiliary program 42 may also read the stored setting values and display these setting values as the default values.

The auxiliary program 42 may be started up not only when the print option is selected, but also when the printer 2 is selected through a device setting (device selection). In this case, the auxiliary program 42 may display an information screen to accept setting values for the items related to color balance. When the auxiliary program 42 receives setting values for the items related to color balance as device settings, the auxiliary program 42 stores information on the received setting values as default print settings.

In the embodiment described above, only printing operations have been described in detail as the operations of the auxiliary program 42, but the auxiliary program 42 may have other roles. Further, the program that executes the processes described in the embodiment is not limited to the auxiliary program 42 but may be another program that receives instructions from the OS 21 or the general-purpose printing program 41 when printing is performed using the general-purpose printing program 41. For example, a print workflow application program having specifications published by Microsoft Corporation may be used as the program.

The execution timing of the auxiliary program 42 is not limited to the examples in the embodiment. For example, the auxiliary program 42 may be executed in response to execution instructions received directly from the OS 21. Alternatively, the auxiliary program 42 may be a resident program, in which case the auxiliary program may perform the operations described above upon receiving an execution command.

In any of the sequence charts and flowcharts disclosed in the embodiment, the plurality of processes that make up any of the plurality of steps may be executed in parallel, or the order in which the processes are performed may be modified in any way that does not produce any inconsistencies in the processes.

The processes disclosed in the embodiments may be executed by a single CPU, a plurality of CPUs, an ASIC or other hardware, or a combination of these components. Further, the processes disclosed in the embodiment may be achieved through a storage medium that stores the programs used to implement those processes or according to any of various other methods or formats.

What is claimed is:

1. A non-transitory computer readable storage medium storing instructions of a support program, the support program being a program corresponding to a printing device connected to an information processing device, the information processing device including a computer, the information processing device having an operating system installed thereon, the operating system including a general-purpose printing program, the instructions of the support program, when executed by the computer, causing the information processing device to perform:
in a case that a print instruction to execute a printing of a target image on the printing device is issued from an application program running on the information processing device to the general-purpose printing program and intermediate data representing the target image is received from the general-purpose printing program,
a preview process of displaying a preview image of the target image on a user interface of the information processing device; and
a settings modification process of, while the preview image is displayed on the user interface, receiving a modification of a setting value for a parameter related to color balance and modifying the setting value; and
in a case that the setting value is modified in the settings modification process,
a print control process of causing the printing device to print the target image according to the modified setting value.

2. The non-transitory computer readable storage medium according to claim 1, wherein the instructions of the support program, when executed by the computer, causes the information processing device to further perform:
in a case that the setting value is modified in the settings modification process,
a preview modification process of updating the preview image on the user interface based on the modified setting value.

3. The non-transitory computer readable storage medium according to claim 1, wherein, in the preview process, the setting value is displayed simultaneously with the preview image on the user interface.

4. The non-transitory computer readable storage medium according to claim 1, wherein the settings modification process includes a reset process of receiving a reset instruction to reset the setting value and of updating the setting value to a default value.

5. The non-transitory computer readable storage medium according to claim 2, wherein, in the preview process, a fixed preview image of the target image is further displayed on the user interface based on the setting value, simultaneously with the preview image displayed on the user interface based on the modified setting value,
wherein the fixed preview image is unchanged in the preview modification process.

6. The non-transitory computer readable storage medium according to claim 1, wherein the instructions of the support program, when executed by the computer, causes the information processing device to further perform:
in a case that the setting value is modified in the settings modification process,
a storage process of storing the modified setting value for the parameter in a memory included in the information processing device, wherein when a previous setting value that is the setting value before the settings modification process is performed is already stored for the parameter in the memory, in the storage process, the previous setting value is overwritten to the modified setting value; and
in a case that, in the storage process, the modified setting value for the parameter is stored in the memory,
a reading process of reading the modified setting value stored in the memory for use in a next printing.

7. The non-transitory computer readable storage medium according to claim 6, wherein the instructions of support program, when executed by the computer, causes the information processing device to further perform:
a storage instruction reception process of receiving a storage instruction to store the modified setting value for the parameter in the memory,
wherein the storage process is performed when the storage instruction is received.

8. The non-transitory computer readable storage medium according to claim 1, wherein the instructions of the support program, when executed by the computer, causes the information processing device to further perform:
in a case that, in the settings modification process, the setting value is modified to the modified setting value,
a storage process of storing the modified setting value for the parameter in a memory included in the information processing device, wherein when one or more setting values are already stored in the memory for the parameter, in the storage process, the modified setting value for the parameter is stored in the memory while maintaining the one or more setting values in the memory so that two or more setting values including the modified setting value are stored in the memory for the parameter,
wherein when the two or more setting values including the modified setting value are already stored in the memory for the parameter, in the settings modification process, a selection of one of the two or more setting values is received as a selected setting value, and the setting value for the parameter is updated to the selected setting value.

9. The non-transitory computer readable storage medium according to claim 1, wherein the instructions of the support program, when executed by the computer, causes the information processing device to further perform:
in a case that the print instruction is issued and the intermediate data is received,
a rasterization process of rasterizing the intermediate data to generate raster data based on the intermediate data,
wherein, in the preview process, the preview image is displayed based on the raster data.

10. The non-transitory computer readable storage medium according to claim 1, wherein the instructions of the support program, when executed by the computer, causes the information processing device to further perform:
a selection reception process of receiving a selection as to whether or not to perform the preview process,
wherein in a case that the print instruction is issued and the intermediate data is received, and additionally the selection to perform the preview process is received in the selection reception process,
the preview process and the settings modification process are performed, and subsequently the print control process is performed,
wherein the instructions of the support program, when executed by the computer, causes the information processing device to further perform:
in a case that the print instruction is issued and the intermediate data is received, and additionally the selection not to perform the preview process is received in the selection reception process,
a second print control process of causing the printing device to print the target image on the printing device based on the setting value without performing the preview process and without performing the settings modification process.
